(19) United States
(12) Patent Application Publication
(10) Pub. No.: US 2017/0316421 A1
(43) Pub. Date: Nov. 2, 2017

(54) EMERGING DEFECT AND SAFETY SURVEILLANCE SYSTEM

(71) Applicant: HRL Laboratories, LLC, Malibu, CA (US)

(72) Inventors: Jiejun Xu, Chino, CA (US); Daniel K. Xie, Gainesville, FL (US); Tsai-Ching Lu, Thousand Oaks, CA (US); John Anthony Cafeo, Farmington, MI (US)

(21) Appl. No.: 15/480,013

(22) Filed: Apr. 5, 2017

Related U.S. Application Data
(60) Provisional application No. 62/318,663, filed on Apr. 5, 2016.

(51) Int. Cl. G06Q 30/00; G07C 5/02; G07C 5/00; G06F 17/30; G06N 7/00

(52) U.S. Cl. CPC G06Q 30/018; G07C 5/02; G07C 5/006; G06Q 30/014; G06N 7/005; G06F 17/30864

(57) ABSTRACT

Described is a system for identifying emerging trends in a consumer product from heterogeneous online data sources. Data extracted from heterogeneous data sources is fused, and consumer product data is identified from the fused data. A baseline distribution for consumer issues related to consumer products is generated from the set of consumer product data. A deviation value from the baseline distribution is determined for a specific consumer product. Indicators for future consumer issues regarding the specific consumer product are identified based on the deviation value. The indicators are reported to a system analyst.

### CROSS-REFERENCE TO RELATED APPLICATIONS

This is a Non-Provisional Application of U.S. Provisional Patent Application No. 62/318,663, filed Apr. 5, 2016, entitled, “Emerging Defect and Safety Surveillance System”, the entirety of which is incorporated herein by reference.

### BACKGROUND OF INVENTION

### (1) Field of Invention

The present invention relates to a system for identifying defects and safety issues in a commercial product and, more particularly, to a system for identifying defects and safety issues in a commercial product through continuous monitoring of online data.

(2) Description of Related Art

The task of identifying emerging events using online user-generated data has previously been tackled by researchers using a variety of methods. This task presents an additionally challenge over other mining tasks due to the temporal nature of the data (see the List of Incorporated Literature References, Literature Reference No. 3). Recent work on this topic tends to focus heavily on the specific mining of data from the social media website Twitter. In general, approaches towards this task attempt to exploit text features and temporal information, as well as a network structure induced from the data to detect emerging events (see Literature Reference Nos. 3 and 5).

When filtered down to the level of commercial product (e.g., vehicle) defect discovery, however, the only previously published work on this subject has been conducted by a group of researchers at Virginia Polytechnic Institute and State University (Virginia Tech). This group focused exclusively on analyzing web forum data. A series of papers was produced by this group on this subject. In the initial paper (see Literature Reference No. 2), three automotive web forums were scraped to obtain information relevant to product defects. A group consisting of graduate and undergraduate students were employed to manually tag 1,500 threads from each of the forums for informativeness regarding potential vehicle defects as well the potential severity of the defect. The researchers concluded that the sentiment analysis was ineffectual for analyzing the thrum data and for predicting vehicle defects, and instead produced a list of “automotive smoke words” that occur more prevalently in posts related to vehicle defects. These smoke words were suggested to be of use in filtering out forum posts that could be used to identify unknown defects or future recall events.

Literature Reference No. 1 is somewhat less topical and focuses solely on the problem of using automated methods to select user postings in automotive web forums with the categories of vehicle components that are mentioned. The techniques mentioned in Literature Reference No. 1 may be of future interest, but are only an accessory to the overall task of identifying emerging events regarding vehicle defects.

The most recent publication (see Literature Reference No. 11) involved using the smoke words from Literature Reference No. 2, as well as other text features, to predict future recalls using machine learning techniques. The authors attempted to predict whether a recall for a given model of vehicle would occur in a given year. Due to the omission or ambiguous reporting of many metrics typically provided to assess the performance of classification tasks, the performance of the classifier was difficult to completely evaluate. Nevertheless, based on the provided reporting and the ratio of years for which there exists vehicle recalls to which there are not, it is believed that the system disclosed in Literature Reference No. 11 will generate many false positives, leading this to be of questionable use for an end-user. Furthermore, the classifiers are not trained to predict recalls at the component level (i.e. they do not attempt to predict which part will be recalled). Instead, suggestions of components that may be recalled are generated from the frequency of their mentions in the tagged forum posts. From the provided figures in Literature Reference No. 11, it was observed that, while there is some overlap in the suggested components that may be recalled and actual components being recalled, the amount of overlap is quite limited and the majority of suggestions are extraneous. Thus, again, this methodology would not be effective for an end-user.

In summary, previous work on commercial product (e.g., vehicle) defect discovery has been limited to the aforementioned research group (Literature Reference No. 2). The work is limited and only explores web forum data as a data source. Thus, a continuing need exists for a system that uses social media and other forms of online data to predict the existence of unknown defects and recalls.

### SUMMARY OF INVENTION

The present invention relates to system for identifying defects and safety issues in a commercial product and, more particularly, to a system for identifying defects and safety issues in a commercial product'through continuous monitoring of online data. The system comprises one or more processors and a non-transitory computer-readable medium having executable instructions encoded thereon such that when executed, the one or more processors perform multiple operations. The system fuses data extracted from a set of heterogeneous data sources. A set of consumer product data is identified from the fused data. A baseline distribution for consumer issues related to a plurality of consumer products is generated from the set of consumer product data. For a specific consumer product, a deviation value is determined from the baseline distribution. Finally, at least one indicator for future consumer issues regarding the specific consumer product is identified based on the deviation value. The at least one indicator is reported to a system analyst.

In another aspect, the consumer issues are safety and/or defect complaints.

In another aspect, the system determines estimated probability mass function (pmf) values for the plurality of consumer products and for the specific consumer product. The estimated pmf values are aggregated, and at least one estimated pmf value is used as an indicator of a consumer product detect and/or potential recall event.

In another aspect, a number of consumer issues is modeled as a binomial distribution and binomial tests are conducted in which low scores are indicative of a consumer product defect and/or potential recall event.

In another aspect, the set of heterogeneous data sources comprises at least two of forum data, information from content aggregation sites, online social media, and online complaint resources.

In another aspect, emergent events regarding vehicle defects and safety are identified.

In another aspect, the at least one indicator is declining engine efficiency of a vehicle.

Finally, the present invention also includes a computer program product and a computer implemented method. The computer program product includes computer-readable instructions stored on a non-transitory computer-readable medium that are executable by a computer having one or more processors, such that upon execution of the instructions, the one or more processors perform the operations listed herein. Alternatively, the computer implemented method includes an act of causing a computer to execute such instructions and perform the resulting operations.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a block diagram depicting the components of a system for identifying defects and safety issues in a commercial product according to some embodiments of the present disclosure;

FIG. 2 is an illustration of a computer program product according to some embodiments of the present disclosure;

FIG. 3 is a flow diagram illustrating the system for identifying defects and safety issues in a commercial product according to some embodiments of the present disclosure;

FIG. 4 illustrates lists of sub-forums crawled from automobile forums according to some embodiments of the present disclosure;

FIG. 5 illustrates lists of keywords used for extracting tweets related to vehicle safety and defects according to some embodiments of the present disclosure;

FIG. 6 is a plot illustrating Twitter co-mentions of vehicle brands and fire-related key terms according to some embodiments of the present disclosure;

FIG. 7 is a plot illustrating Twitter co-mentions of a specific vehicle brand and vehicle component terms according to some embodiments of the present disclosure;

FIG. 8 illustrates an overview of the statistical estimation module according to embodiments of the present disclosure;

FIG. 9 is a plot illustrating computed p-values ordered by magnitude according to some embodiments of the present disclosure;

FIG. 10 is a table illustrating the twenty most problematic consumer issues for vehicles by differences in observed frequencies according to some embodiments of the present disclosure;

FIG. 11 is a table illustrating the twenty most problematic consumer issues for vehicles by binomial test according to some embodiments of the present disclosure; and

FIG. 12 is an illustration of dashboards showing analyzed results from online social media and a consumer reporting site according to some embodiments of the present disclosure.

### DETAILED DESCRIPTION

The present invention relates to a system for identifying defects and safety issues in a commercial product and, more particularly, to a system for identifying defects and safety issues in a commercial product through continuous monitoring of online data. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein.

In the following detailed description, numerous specific details are set forth in order to provide a more thorough understanding of the present invention. However, it will be apparent to one skilled in the art that the present invention may be practiced without necessarily being limited to these specific details. In other instances, well-known structures and devices are shown in block diagram form, rather than in detail, in order to avoid obscuring the present invention.

The reader's attention is directed to all papers and documents which are filed concurrently with this specification and which are open to public inspection with this specification, and the contents of all such papers and documents are incorporated herein by reference. All the features disclosed in this specification, (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Furthermore, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” or “act of” in the claims herein is not intended to invoke the provisions of 35 U.S.C. 112, Paragraph 6.

Before describing the invention in detail, first a list of cited references is provided. Next, a description of the various principal aspects of the present invention is provided. Subsequently, an introduction provides the reader with a general understanding of the present invention. Finally, specific details of various embodiment of the present invention are provided to give an understanding of the specific aspects.

(1) List of incorporated Literature References

The following references are cited and incorporated throughout this application. For clarity and convenience, the references are listed herein as a central resource for the reader. The following references are hereby incorporated by reference as though fully set forth herein. The references are cited in the application by referring to the corresponding literature reference number.

1. A. S. Abrahams, J. Jiao, W. Fan, G. A. Wang, and Z. Zhang. What's buzzing in the blizzard of buzz? automotive component isolation in social media postings. Decision Support. Systems, 55(4):871-882, 2013.

2. A. S. Abrahams, J. Jiao, G. A. Wang, and W. Fan. Vehicle defect discovery from social media. Decision Support Systems, 54(1):87-97, 2012.

3. C. C. Aggarwal and K. Subbian. Event detection in social streams. In SDM, volume 12, pages 624-635. SIAM, 2012.

4. H. Becker, M. Naaman, and L. Gravano. Beyond trending topics: Real-world event identification on twitter, ICWSM, 11:438-441 2011.

5. M. Cataldi, L. Di Caro, and C. Schifanella. Emerging topic detection on twitter based on temporal and social terms evaluation. In Proceedings of the Tenth International Workshop on Multimedia Data Mining, page 4. ACM, 2010.

6. R. Compton, D. Jurgens, and D. Allen. Geotagging one hundred million twitter accounts with total variation minimization. In 2014 IEEE International Conference on Big Data, Big Data 2014, Washington, DC, USA, Oct. 27-30, 2014, pages 393-401, 2014.

7. H. Kwak, C. Lee, H. Park, and S. Moon. What is twitter, a social network or a news media? In Proceedings of the 19th international Conference on World Wide Web, WWW'10, pages 591-600, New York, N.Y., USA, 2010. ACM.

8. M. Mathiondakis and N. Koudas. Twittermonitor: Trend detection over the twitter stream. In Proceedings of the 2010 ACM SIGMOD International Conference on Management of data, pages 1155-1158. ACM, 2010.

9. T. Sakaki, M. Okazaki, and Y. Matsuo. Earthquake shakes twitter users: Real-time event detection by socialsensors, In Proceedings of the 19th International Conference on World Wide Web, WWW'10, pages 851-860, New York, N.Y., USA, 2010. ACM.

10. J. Weng and B.-S. Lee. Event detection in twitter. ICWSM. 11:401-408, 2011.

11. X. Zhang, S. Niu, D. Zhang, G. A. Wang, and W. Fan. Predicting vehicle recalls with user-generated contents: A text mining approach. In Intelligence and Security informatics—Pacific Asia Workshop, PAISI 2015, Ho Chi Minh City, Vietnam, May 19, 2015. Proceedings, pages 41-50, 2015.

(2) Principal Aspects

Various embodiments of the invention include three “principal” aspects. The first is a system for identification of defects and safety issues in a commercial product. The system is typically in the form of a computer system operating software or in the form of a “hard-coded” instruction set. This system may be incorporated into a wide variety of devices that provide different functionalities. The second principal aspect is a method, typically in the form of software, operated using a data processing system (computer). The third principal aspect is a computer program product. The computer program product generally represents computer-readable instructions stored on a non-transitory computer-readable medium such as an optical storage device, e.g., a compact disc (CD) or digital versatile disc (DVD), or a magnetic storage device such as a floppy disk or magnetic tape. Other, non-limiting examples of computer-readable media include hard disks, read-only memory (ROM), and flash-type memories. These aspects will be described in more detail below.

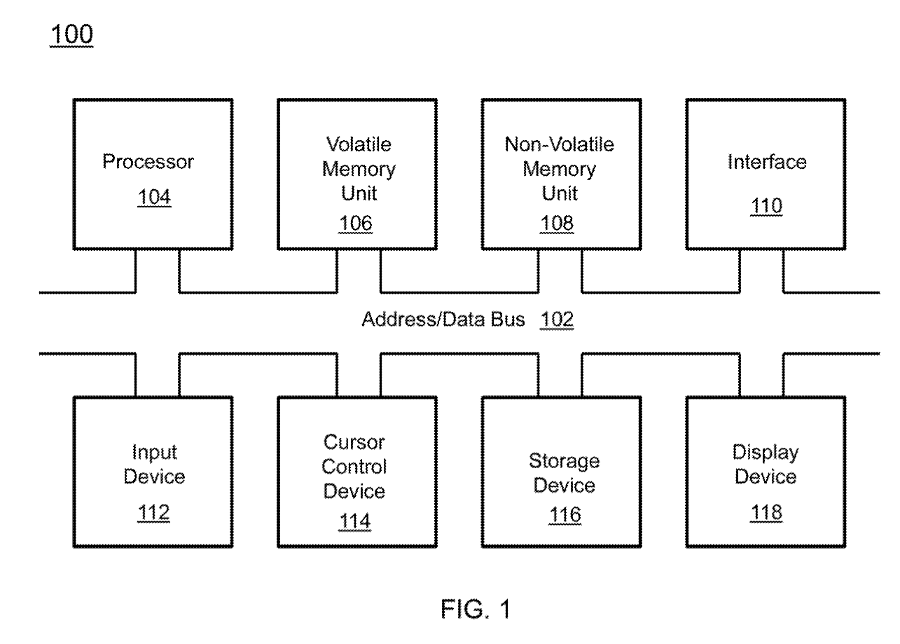

A block diagram depicting an example of a system (i.e., computer system 100) of the present invention is provided in FIG. 1. The computer system 100 is configured to perform calculations, processes, operations, and/or functions associated with a program or algorithm. In one aspect, certain processes and steps discussed herein are realized as a series of instructions (e.g., software program) that reside within computer readable memory units and are executed by one or more processors of the computer system 100. When executed, the instructions cause the computer system 100 to perform specific actions and exhibit specific behavior, such as described herein.

The computer system 100 may include, an address/data has 102 that is configured to communicate information. Additionally, one or more data Processing units, such as a processor 104 (or processors), are coupled with the address/data bus 102. The processor 104 is configured to process information and instructions. In an aspect, the processor 104 is a microprocessor. Alternatively, the processor 104 may be a different type of processor such as a parallel processor, application-specific integrated circuit (ASIC), programmable logic array (PLA), complex programmable logic device (CPLD), or a field programmable gate array (FPGA).

The computer system 100 is configured to utilize one or more data storage units. The computer system 100 may include a volatile memory unit 106 (e.g., random access memory (“RAM”), static RAM, dynamic RAM, etc.) coupled with the address/data bus 102, wherein a volatile memory unit 106 is configured to store information and instructions for the processor 104. The computer system 100 further may include a non-volatile memory unit 108 (e.g., read-only memory (“ROM”), programmable ROM (“PROM”), erasable programmable ROM (“EPROM”), electrically erasable programmable ROM “EEPROM”), flash memory, etc.) coupled with the address/data bus 102, wherein the non-volatile memory unit 108 is configured to store static information and instructions for the processor 104. Alternatively, the computer system 100 may execute instructions retrieved from an online data storage unit such as in “Cloud” computing. In an aspect, the computer system 100 also may include one or more interfaces, such as an interface 110, coupled with the address/data bus 102. The one or more interfaces are configured to enable the computer system 100 to interface with other electronic devices and computer systems. The communication interfaces implemented by the one or more interfaces may include wireline (e.g., serial cables, modems, network adaptors, etc.) and/or wireless (e.g., wireless modems, wireless network adaptors, etc.) communication technology.

In one aspect, the computer system 100 may include an input device 112 coupled with the address/data bus 102, wherein the input device 112 is configured to communicate information and command selections to the processor 100. In accordance with one aspect, the input device 112 is an alphanumeric input device, such as a keyboard, that may include alphanumeric and/or function keys. Alternatively, the input device 112 may be an input device other than an alphanumeric input device. In an aspect, the computer system 100 may include a cursor control device 114 coupled with the address/data bus 102, wherein the cursor control device 114 is configured to communicate user input information and/or command selections to the processor 100. In an aspect, the cursor control device 114 is implemented using a device such as a mouse, a track-ball, a track-pad, an optical tracking device, or a touch screen. The foregoing notwithstanding, in an aspect, the cursor control device 114 is directed and/or activated via input from the input device 112, such as in response to the use of special keys and key sequence commands associated with the input device 112. In an alternative aspect, the cursor control device 114 is configured to be directed or guided by voice command.

In an aspect, the computer system 100 further may include one or more optional computer usable data storage devices, such as a storage device 116, coupled with the address/data bus 102. The storage device 116 is configured to store information and/or computer executable instructions. In one aspect, the storage device 116 is a storage device such as a magnetic or optical disk drive (e.g., hard disk drive “HDD”), floppy diskette, compact disk read only memory (“CD-ROM”), digital versatile disk (“DVD”)). Pursuant to one aspect, a display device 118 is coupled with the address/data bus 102, wherein the display device 118 is configured to display video and/or graphics. In an aspect, the display device 118 may include a cathode ray tube (“CRT”), liquid crystal display (“LCD”), field emission display (“FED”), plasma display, or any other display device suitable for displaying video and/or graphic images and alphanumeric characters recognizable to a user.

The computer system 100 presented herein is an example computing environment in accordance with an aspect. However, the non-limiting example of the computer system 100 is not strictly limited to being a computer system. For example, an aspect provides that the computer system 100 represents a type of data processing analysis that may be used in accordance with various aspects described herein. Moreover, other computing systems may also be implemented. Indeed, the spirit and scope of the present technology is not limited to any single data processing environment. Thus, in an aspect, one or more operations of various aspects of the present technology are controlled or implemented using computer-executable instructions, such as program modules, being executed by a computer. In one implementation, such program modules include routines, programs, objects, components and/or data structures that are configured to perform particular tasks or implement particular abstract data types. In addition, an aspect provides that one or more aspects of the present technology are implemented by utilizing one or more distributed computing environments, such as where tasks are performed by remote processing devices that are linked through a communications network, or such as where various program modules are located in both local and remote computer-storage media including memory-storage devices.

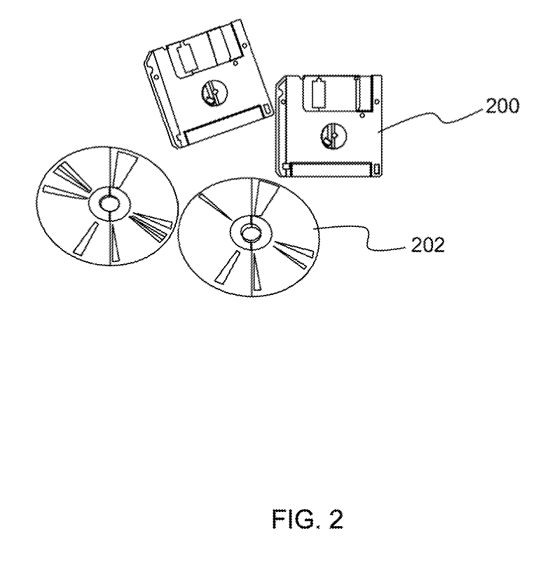

An illustrative diagram of a computer program product (i.e., storage device) embodying the present invention is depicted in FIG. 2. The computer program product is depicted as floppy disk 200 or an optical disk 202 such as a CD or DVD. However, as mentioned previously, the computer program product generally represents computer-readable instructions stored on any compatible non-transitory computer-readable medium. The term “instructions” as used with respect to this invention generally indicates a set of operations to be performed on a computer, and may represent pieces of a whole program or individual, separable, software modules. Non-limiting examples of “instruction” include computer program code (source or object code) and “hard-coded” electronics (i.e. computer operations coded into a computer chip). The “instruction” is stored on any non-transitory computer-readable medium, such as in the memory of a computer or on a floppy disk, a CD-ROM, and a flash drive. In either event, the instructions are encoded on a non-transitory computer-readable medium.

(3) Introduction

Described is an automated system to identify emerging trends on commercial product (e.g., vehicle) defects and related safety issues by continuously collecting and monitoring publicly available online data. The system according to embodiments of the present disclosure provides a smart data collection module to integrate heterogeneous open source data, which including social media, vehicle enthusiast forums, and online consumer reporting sites. Based on the collected data, the system provides real-time detection of any on-going consumer issues with vehicles, such as those pertaining to recalls. More importantly, the system described herein is capable of identifying early indicators for emerging safety-related trends prior to its widespread to the general public. This is accomplished by a statistical method which estimates the baseline distribution of observing vehicle defective components from the heterogeneous data sources and subsequently identifies irregularities. A web interface is also described to demonstrate the overall integrated system.

Previous work on employing online data to analyze and predict vehicle recalls and other events related to vehicle defects focused exclusively on web forum data. The system described herein goes beyond the prior art to employ data from several heterogeneous sources. In addition to collecting traditional web forum data, information from content aggregation sites (e.g., Reddit), social network services (e.g., Twitter), and topical online complaint resources (e.g., car complaint websites) is collected. There are many advantages towards utilizing multiple differing data sources. One immediate advantage is that these sites have differing user bases, allowing one to gather information from diverse segments of the population. Another advantage is that some of the new sources utilized allow one to gather higher quality data, in that the information gathered is immediately specific to the given problem and possesses a high level of detail about potential issues. Such data allows one to perform analysis beyond that which was done by previous researchers.

Significantly, the system according to embodiments of the present disclosure allows end-users to monitor the impact of vehicle defects through employing information obtained by collecting data from multiple online sources. The system enables one to pinpoint troublesome issues to the level of specific vehicle models, years, and general categories of vehicle components (e.g., engine problems, fuel system problems). Each of these aspects will be described in detail below.

(4) Specific Details of Various Embodiments

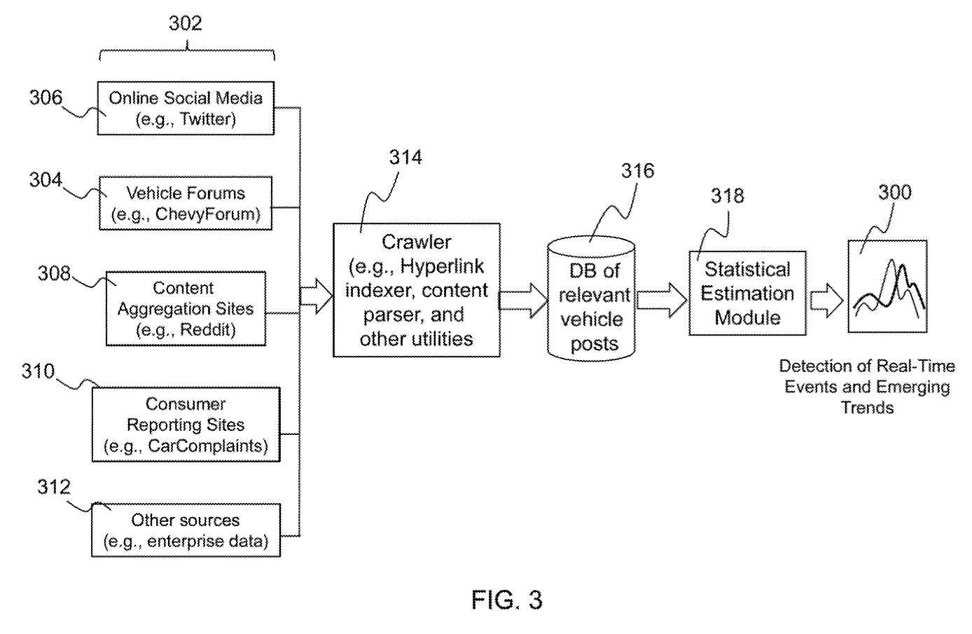

FIG. 3 depicts the components that form the core of the system described herein. As described above, the system according to embodiments of the present disclosure performs detection of real-time events and emerging trends (element 300) by capturing data from multiple heterogeneous online sources 302. In one embodiment, the system detects and assesses problematic vehicle defects and potential future vehicle recalls. The heterogeneous online sources 302 range from traditional web forum data (e.g., vehicle forums 304) to social network services (i.e., online social media 306), content aggregation sites 308, consumer reporting sites 310, and other sources 312 (e.g., enterprise data). The collected information from the disparate heterogeneous online sources 302 is fused together to provide several levels of information about potential recalls relevant to an analyst. Statistical analysis on the data from consumer reporting sites 310 is the primary method for identifying emergent events regarding vehicle defects and vehicle safety (element 300). The other sources of information from the heterogeneous online sources 302 are used to supplement this data to provide additional information on the nature of the problem.

(4.2) Smart Data Collection

(4.1.1) Online Social Media (Element 306)

Online social media 306 and microblogging platforms have been shown to be useful in real-world event tracking and monitoring. In particular, Twitter has been shown to be extremely relevant, as it has been studied extensively in the literature (see Literature Reference Nos. 4 and 7-9). For the purposes of the invention described herein, Twitter data was obtained via subscription to the GNIP1 Twitter Decahose service, which contains a 10% sample of random public Tweets. The GNIP data stream is delivered to the system according to embodiments of the present disclosure in real-time and stored in a Haddop Distributed File System deployed across a multi-node and multi-core cluster with combined memory in the terabyte scale. For instance, a multi-core computing cluster having an 1824 central processing unit (CPU) core, a combined memory of 3520 gigabytes (3.52 terabytes (TB)), and a total of more than 1.2 petabytes (PB) data storage can be utilized.

(4.1.2) Forums (Element 304)

In addition to online social media 302, data was obtained from web forums 304 for automobile enthusiasts and automotive troubleshooting. A web crawler 314 was constructed that is able to extract all previous posts from web forums 304 (and heterogeneous online sources 302) contained in all sub-forums of interest. Accessory information, such as post times, user names, and thread titles, is also captured. This data is then stored in a standardized format for future use to the end-user. The web crawler 314 is able to selectively crawl individual sub-forums and can be ran by itself through a command line prompt. Additionally, an optional delay can be incorporated between crawling different forum threads in the web crawler 314 to prevent potential blocking of internet protocol (IP) addresses due to heavy traffic from one source.

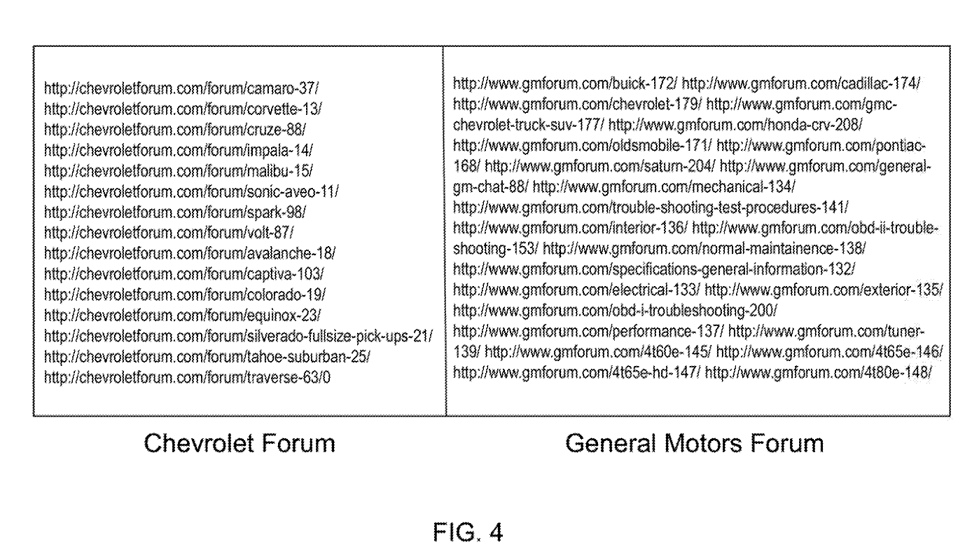

The web crawler 314 has been used to successfully gather all pertinent posts from previous web sites going back to over a decade. FIG. 4 displays a list of sub-forums that have been crawled for respective sites (i.e., Chevrolet and General Motors (GM)). By tagging posts that mention specific vehicle models and years after potential vehicle quality issues are identified, the posts can be used to provide the end-user additional details regarding consumer issues with vehicles. Moreover, there is additional potential, using the reply structure of posts, to identify particularly influential users or domain experts to gain additional insight into potential issues.

(4.1.3) Content Aggregation Sites (Element 308)

There is access to many years of publicly available complete post data for the content aggregation site 308 Reddit, which has many specific bulletin boards (“subreddits”) for vehicle maintenance and vehicle enthusiasts. This data can be painlessly accessed through the use of large data processing tools, such as Google BigQuery. This data can be employed much like the forum data (element 304) as an auxiliary source of data to provide the end-user with additional details about vehicle issues.

(4.1.4) Consumer Reporting Sites (Element 310)

A consumer reporting site 310 for vehicle-related complaints was also crawled using the crawler 314 (or specialized scraper). The web crawler 314 reviews the structure and layout of the web page and extracts specific information based on HTML (Hypertext Markup Language) tags, Information about vehicle complaints was extracted from the website on two different levels. On one level, for a given vehicle model and year, the number of complaints in a general category of complaints grouped by type of component (e.g., engine) was extracted. On another level, a more specific description of those same complaints with a given numerical score for how many users reported a similar specific complaint was extracted. Additionally, aggregate information about NHTSA (National Highway Traffic Safety Administration) complaints for a given vehicle model and year using the same source was extracted. The web crawler 314 is able to selectively pull information for specific brands and can also be set to automatically ignore models with a number of complaints below a given threshold. The scraper (web crawler 314) has been successfully utilized to gather relevant complaint data for all four current GM brands. In addition, one can easily use the web crawler 314 to pull complaint information about rival car manufacturer brands. Such information about the reliability of the models of other manufacturers may prove useful in the future for quality control or marketing purposes.

(4.2) Algorithm Description

(4.2.1) Real-Time Event Detection

Given a massive collection of Twitter posts, the system according to the embodiments of the present disclosure searches each post for 1) mentions for product (e.g., vehicle) brands (e.g., “Chevrolet”, “Cadillac”, “Honda”, “Toyota”), and 2) a set of carefully selected safety and defect related keywords. Essentially, this pipeline is a cascade of filters which is used to continually monitor and detect events of interest from a large data stream in real-time Posts passing through both filters (brand filter and keyword filter) are considered to be related to issues on vehicle safety and defect. The underlying assumption for the keyword based filter is that related words would show an increase in the usage when an event is unfolding (see Literature Reference No. 10). Therefore, an event can be identified if the related keywords showing burst in appearance count.

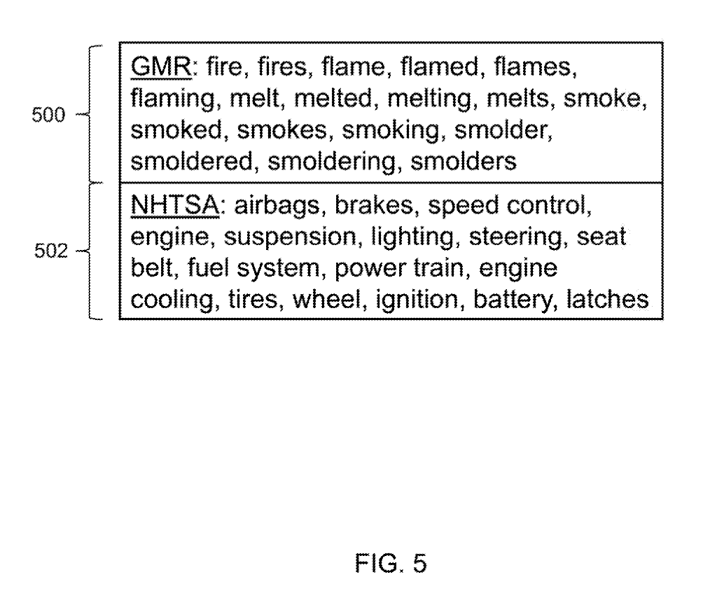

In one embodiment, the system focused on two lists of keywords. The first list contained words with fire-related semantics (e.g., fire, flames, melt). The second list contained words harvested from the 2015 NHTSA Defect Investigations Database 3. The second list consisted of the most common defective components (e.g., airbags, brakes, steering) mentioned in the database. The complete keywords of both lists are shown in FIG. 5. Note that the first list (element 500) attempts to identify general fire-related safety events, and the second list (element 502) focuses on finding safety events related to specific vehicle components.

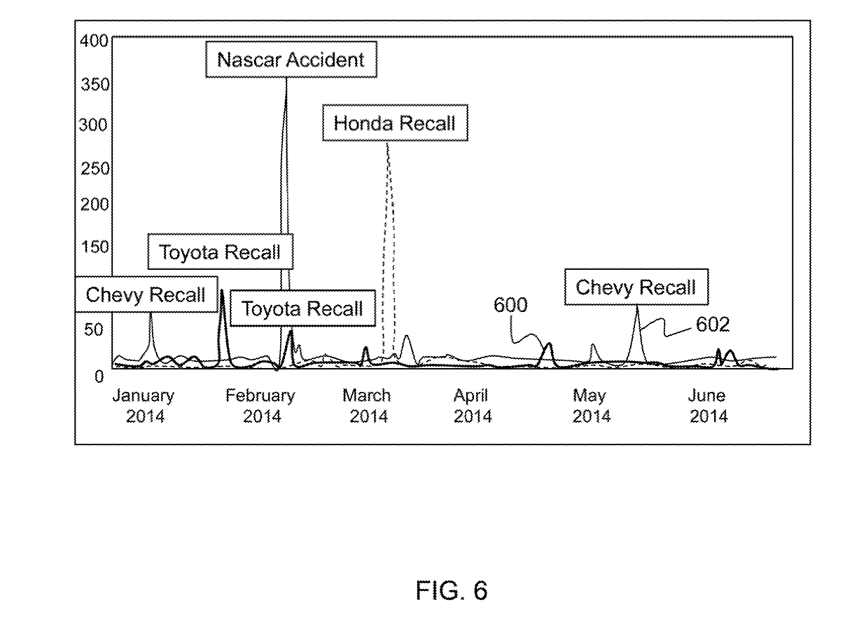

FIG. 6 is a plot of time series of co-mentions of vehicle brands and fire-related keywords from January, 2014 to June, 2014. Multiple spikes, corresponding to various vehicle safety events can be observed from the time series. For instance, there were two major recalls for Toyota (bold line 600) identified, which were related to the fire hazard/incidences caused by the cruiser with improper fuel tubes. Similarly, several spikes were observed for Chevrolet (solid unbolded line 602), which were related to the recalls on several truck and sport utility vehicle (SUV) models due to fire risk.

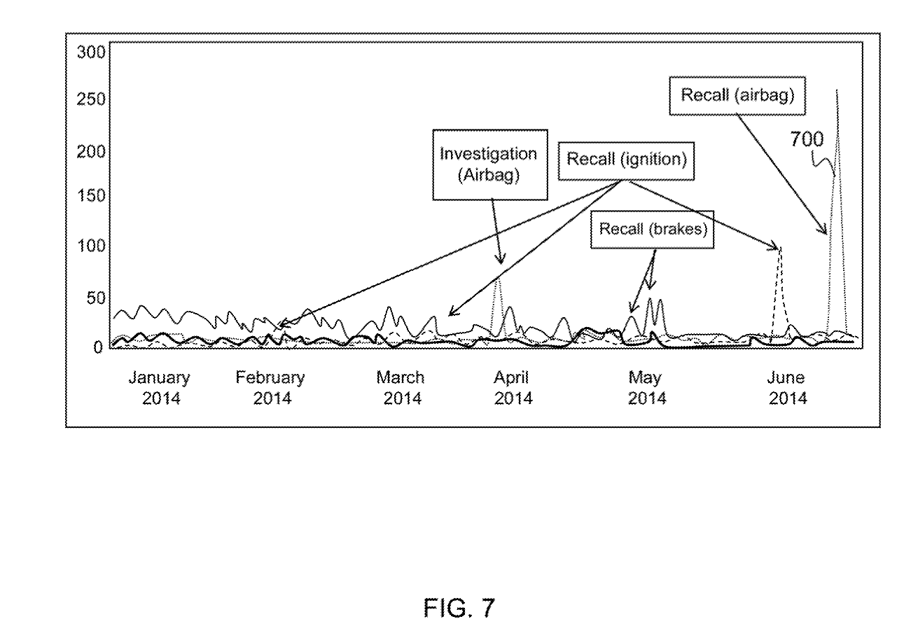

FIG. 7 depicts the time series of co-mentions of the brand “Chevrolet” and several vehicle components. A large spike (element 700) is seen in June for “airbag”, which is related to the massive recall of the Chevrolet Cruze for potential airbag glitches. An important aspect of the detection system according to embodiments of the present disclosure is that the geographic location where the social media posts/warnings are coming from can be precisely identified. This accomplished by leveraging the large geo-location database of Twitter users identified in prior work (see Literature Reference No. 6). It is believed that the spatial-temporal information generated from the system described herein is crucial for business operations.

(4.2.2) Emerging Trend Detection (Element 300)

The following section includes a description of how the system according to embodiments of the present disclosure is capable of identifying early indicators for emerging safety-related trends prior to its widespread to the general public. In one embodiment, the primary method of detecting emerging events related to vehicle defects is through statistical analysis of the data (i.e., statistical estimation module 318) from a consumer reporting site 310. The relative frequency of types of car complaints over all years and models for which data was collected was used to generate a baseline distribution for how often a specific type of complaint should be expected. For each year and model, the relative frequency of complaints for that specific year and model were computed. It was found that there was a marked difference in the distribution of type of complaints between all years and models and those specifically for the 2006 Malibu.

The estimated distributions were used to compute two metrics indicative of whether there is a potential issue with a category of vehicle component for a given model and year. For the first metric (metric 1), the estimated probability mass functions (pint) for complaints for a specific year and model and for complaints for all years and models were investigated. Then, these values were aggregated, and the high values this metric takes were used as being indicative of a potential issue. Specifically, for the first metric, the difference value between the observed relative frequency of a type of complaint aggregated over all years and models and the observed relative frequency of that type of complaint for a specific year and model is determined. Then, the difference values are aggregated, and the largest values (absolute values) are used as being indicative of potential issues.

For the second metric (metric 2), the number of complaints that occurred in a given category were modeled as a binomial distribution and binomial tests were conducted. This is accomplished by assuming incoming complaints follow independent Bernoulli processes, with success if the complaint falls in the distinguished category and failure if it falls in another category. Assume a given model and year has x observed complaints in category c and n complaints across all categories. Let p_{c} be the relative frequency of complaints for a given category c across all years and models. Let X_{c} be a random variable representing the number of complaints in category c for the given model and year with n total complaints across all categories, which it is assumed follows a binomial distribution with fixed trial number n and probability of success θ unknown. For the second metric, the probability of the upper-tail event {X_{c}≧x} if X_{c}˜binom(p_{c}, n) was investigated. The resulting scores are p-values for one-sided binomial tests with the hypotheses:

H₀:θ=p_{c}

H^{A}:θ>p_{c}.

in which low scores are indicative of a vehicle defect and/or potential recall event.

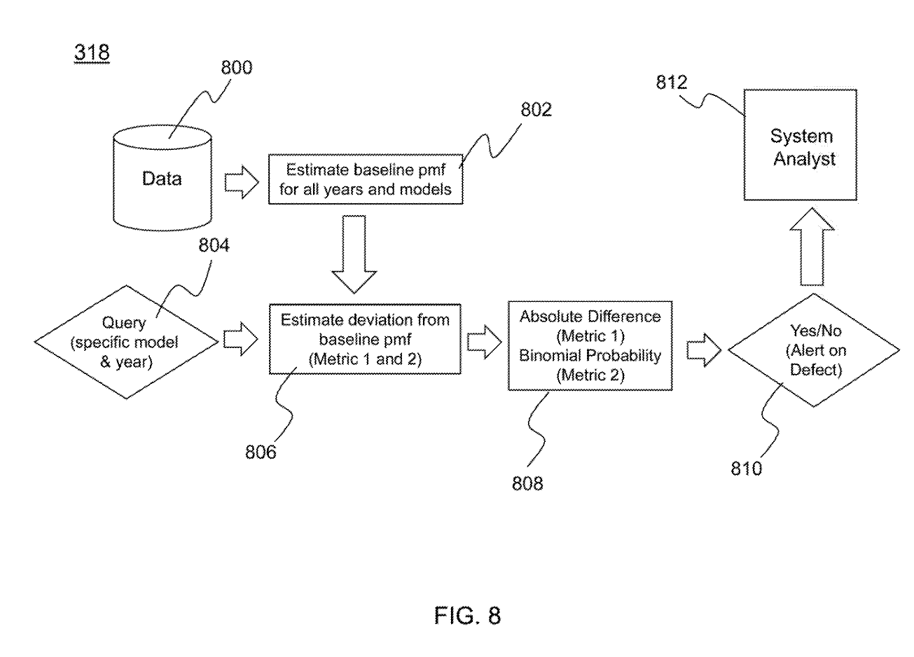

FIG. 8 shows an overview of the statistical estimation module 318 for detecting emerging trends. From the data 800 obtained from the database of relevant vehicle posts (FIG. 3, element 316), a baseline pmf for all vehicle years and models is determined (element 802). A query 804 for a specific vehicle model and year is performed, and the deviation from the baseline pmf (metrics 1 and 2) is determined for the specific vehicle model and year (element 806). Next, an absolute difference (metric 1) and binomial probability (metric 2) are determined (element 808), as described above. Based on the determined metrics. an alert (indicator) is generated based on a defect (complaint) (element 810). Finally, the alert is sent to a system analyst (element 812). The system analyst 812 may be a natural person or, alternatively, a central server configured to accept defect alerts and issue notices to particular consumers.

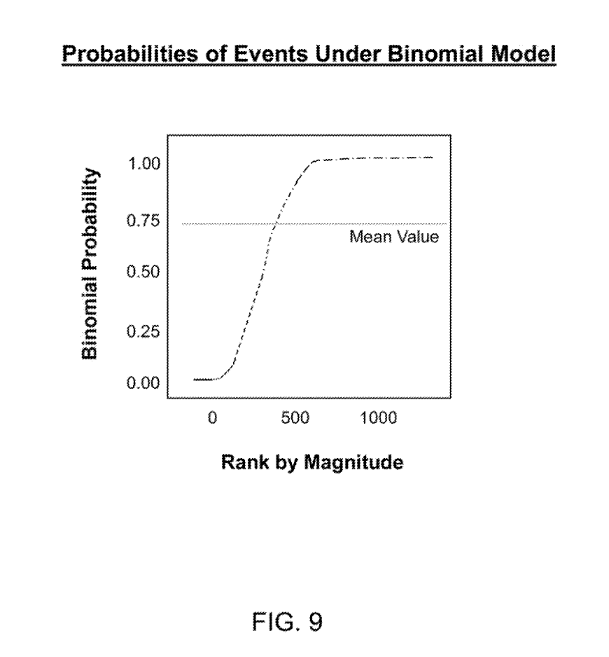

FIG. 9 is a plot illustrating computed values of the second metric, where each segment of the curve (represented by different line types (e.g., dashed, solid) represents a different interval. The plot in illustrates the cumulative probability distribution (CDF) of events ordered by magnitude computed using the second metric. The shape of the CDF curve fits a typical binomial distribution. The various segments of the line (solid pattern, dashed patterns) indicate different ranges of the CDF. Further, the plot in FIG. 9 indicates that this metric is able to filter out certain categories of vehicle components as being particularly problematic (i.e., the test has sufficient power). It is believed that other metrics may also prove useful for future applications, such as likelihood ratios or f˜divergences (e.g. Kullback-Leibler divergence, χ2 divergence, Hellinger distance), although they have not been tested. Note that the natural χX2 goodness-of-fit test between two probability distributions does not appear to be immediately useful with the task according to embodiments of the present disclosure due to low expected counts for certain categories, thus requiring the collapse of categories for proper application. Based on the shape (i.e., change pattern) of the distribution, there is enough separation power to rank and classify normal versus problematic vehicle component categories.

(4.2.3) Evaluation of Method

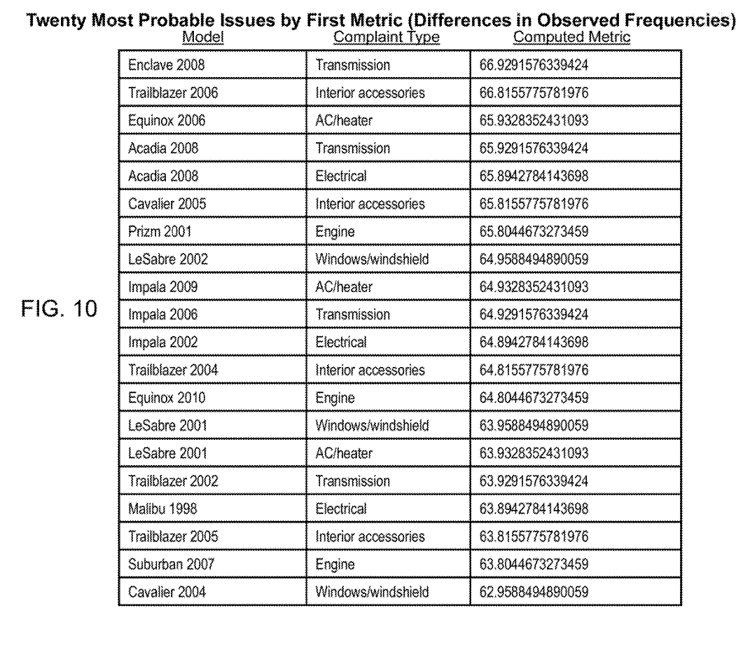

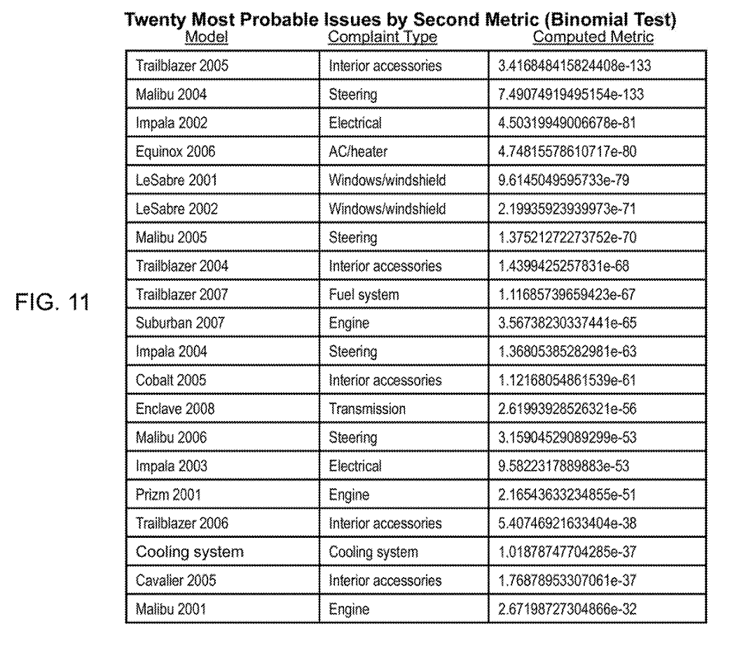

Through examination of the twenty most problematic groupings of vehicle models, years, and category of components returned by both of the metrics described above, the identification of numerous vehicle defects/recalls which are believed should have been able to have been identified in advance was accomplished. These include the power steering recalls for the 2004, 2005, and 2006 Chevy Malibu, the power steering recall for the 2006 Chevy Cobalt, the transmission issue for the 2008 Buick Enclave, and the faulty fuel gauges for the 2006 Trailblazer. FIGS. 10 and 11 are tables that present results from verification using the first metric and the second metric, respectively. Further inspection of these complaints through other sources should quickly confirm the presence of these given issues.

(4.3) Web Interface

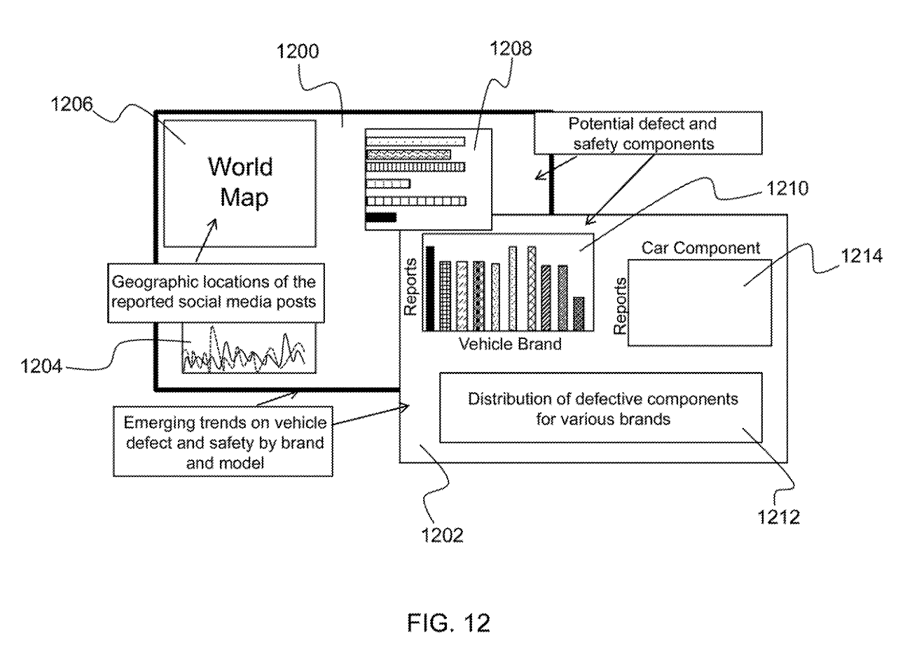

To facilitate user adaptation and knowledge sharing across groups/organizations/communities, a front-end web interface using Tableau 4 (developed by Tableau located at 1621 N 34th St., Seattle, Wash. 98103) was developed to visualize the results and analysis based on the method according to embodiments of the present disclosure. FIG. 12 depicts two example Tableau dashboards constructed specifically for the Twitter social media platform (back dashboard 1200) and a consumer reporting platform (front dashboard 1202). A diverse collection of information is shown in each dashboard. For instance, the social media dashboard (element 1200) displays the aggregated time series of relevant posts on safety issues 1204, geographic distributions of the social media posts 1206, as well as percentage of vehicle components discussed in the extracted posts 1208. Similarly, the consumer report dashboard (element 1202) displays complaints regarding specific model and year of vehicles (element 1210), distribution of defective components for various brands (element 1212), and variations in the number of complaints of different components (element 1214).

In summary, the invention described herein is an end-to-end system to identify emerging trends on vehicle defects and related safety, issued, as well as to investigate potential future vehicle recalls. The system according to embodiments of the present disclosure is able to identify issues at the level of specific categories of vehicle components. Additionally, the system incorporates data from heterogeneous sources of online user-generated content.

Although vehicles were used for illustrated purposes, as can be appreciated by one skilled in the art, the system can be alternatively applied to any type of consumer product that may be affected by defects and/or safety issues. The system is applicable to monitoring emerging trends for a wide range of products, ranging from consumer goods and commodities (e.g., electronics, appliances) to commercial and industrial equipment (e.g., aircraft, large machinery). In an increasingly connected world with ubiquitous computing and network connectivity, it is extremely rare for any product to have invisible online traces. For instance, there are more than dozens of retailer websites online to be explored if one is interested in monitoring trends for electronic products (e.g., camera, television). In addition, there are data from Better Business Bureaus and other fine-grained statistics from regional government agencies to be analyzed in conjunction. Once the data is collected, the statistical estimation method described herein can be applied to the application in a seamless fashion.

Similar claims can be extended to scenarios where there are physical sensors as opposed to “human sensors.” For example, there are a multitude of sensors deployed across aircraft, watercraft, and vehicles of different types. As a non-limiting example, a vehicle sensor can monitor how much fuel is needed to power a vehicle. Increases in fuel amounts over time would indicate a declining efficiency of the engine, which would require maintenance. Additionally, a sensor that detects impending failures and notifies users (e.g., crew, ground stations) is a non-limiting example of a physical sensor. Furthermore, vehicle sensors that can identify unusual events in in real-time (e.g., problems with braking operation) and proactively take actions on potential performance issues (e.g., generate a visual or auditory alert for the vehicle operator) are applicable to the invention described herein, “Complaints” are generated in the forms of error messages from these sensors. The method of estimating baseline error distribution and deviation according to embodiments of the present disclosure provides valuable cues on emerging defects and/or failures.

The system according to embodiments of the present disclosure has applications in emerging event detection, management of product recalls, quality control, and brand management at manufacturing corporations, such as vehicle manufacturing corporations. Additionally, in the field of aerospace, the invention described herein provides applications towards quality control, multi-modal sensor fusion (i.e., combining signals from multiple sensor types (e.g., engine sensor, temperature sensor)), health management (e.g., airplane health (monitoring), and passenger satisfaction (e.g., cabin, occupant system).

Finally while this invention has been described in terms of several embodiments, one of ordinary skill in the art will readily recognize that the invention may have other applications in other environments. It should be noted that many embodiments and implementations are possible. Further, the following claims are in no way intended to limit the scope of the present invention to the specific embodiments described above. In addition, any recitation of “means for” is intended to evoke a means-plus-function reading of an element and a claim, whereas, any elements that do not specifically use the recitation “means for”, are not intended to be read as means-plus-function elements, even if the claim otherwise includes the word “means”. Further, while method steps have been recited in an order, the method steps may occur in any desired order and fall within the scope of the present invention.

What is claimed is:

1. A system for identifying potential defects and safety issues in a consumer product, the system comprising:
one or more processors and a non-transitory computer-readable medium having executable instructions encoded thereon such that when executed, the one or more processors perform operations of:
fusing data extracted from a set of heterogeneous data sources;
identifying a set of consumer product data from the fused data;
generating a baseline distribution for consumer issues related to a plurality of consumer products from the set of consumer product data;
for a specific consumer product, determining a deviation value from the baseline distribution;
identifying at least one indicator for future consumer issues regarding the specific consumer product based on the deviation value; and
reporting the at least one indicator to a system analyst.

2. The system set forth in claim 1, wherein the consumer issues are safety and/or defect complaints.

3. The system as set forth in claim 1, where the one or more processors perform operations of:
determining estimated probability mass function (pmf) values for the plurality of consumer products and for the specific consumer product;
aggregating the estimated pmf values; and
using at least one estimated pmf value as an indicator of a consumer product defect and/or potential recall event.

4. The system as set forth in claim 1, wherein the one or more processors perform an operation of modeling a number of consumer issues as a binomial distribution and conducting binomial tests in which low scores are indicative of a consumer product defect and/or potential recall event.

5. The system as set forth in claim 1, wherein the set of heterogeneous data sources comprises at least two of forum data, information from content aggregation sites, online social media, and online complaint resources.

6. The system as set forth in claim 1, wherein the one or more processors further perform an operation of identifying emergent events regarding vehicle defects and safety.

7. A computer implemented method for identifying potential defects and safety issues in a consumer product, the method comprising an act of:
causing one or more processers to execute instructions encoded on a non-transitory computer-readable medium, such that upon execution, the one or more processors perform operations of:
fusing data extracted from a set of heterogeneous data sources;
identifying a set of consumer product data from the fused data;
generating a baseline distribution for consumer issues related to a plurality of consumer products from the set of consumer product data;
for a specific consumer product, determining a deviation value from the baseline distribution;
identifying at least one indicator for future consumer issues regarding the specific consumer product based on the deviation value; and
reporting the at least one indicator to a system analyst.

8. The method as set forth in claim 7, wherein the consumer issues are safety and/or defect complaints.

9. The method as set forth in claim 7, wherein the one or more processors perform operations of:
determining estimated probability mass function (pmf) values for the plurality of consumer products and for the specific consumer product;
aggregating the estimated pmf values; and
using at least one estimated pmf value as an indicator of a consumer product defect and/or potential recall event.

10. The method as set forth in claim 7, wherein the one or more processors perform an operation of modeling a number of consumer issues as a binomial distribution and conducting binomial tests in which low scores are indicative of a consumer product defect and/or potential recall event.

11. The method as set forth in claim 7, wherein the set of heterogeneous data sources comprises at least two of forum data, information from content aggregation sites, online social media, and online complaint resources.

12. The method as set forth in claim 7, wherein the one or more processors further perform an operation of identifying emergent events regarding vehicle defects and safety.

13. A computer program product for identifying potential defects and safety issues in a consumer product, the computer program product comprising:
computer-readable instructions stored on a non-transitory computer-readable medium that are executable by a computer having one or more processors for causing the processor to perform operations of:
fusing data extracted from a set of heterogeneous data sources;
identifying a set of consumer product data from the fused data;
generating a baseline distribution for consumer issues related to a plurality of consumer products from the set of consumer product data;
for a specific consumer product, determining a deviation value from the baseline distribution;
identifying at least one indicator for future consumer issues regarding the specific consumer product based on the deviation value; and
reporting the at least one indicator to a system analyst.

14. The computer program product as set forth in claim 13, wherein the consumer issues are safety and/or defect complaints.

15. The computer program product as set forth in claim 13, further comprising instructions for causing the one or more processors to further perform operations of:
determining estimated probability mass function (pmf) values for the plurality of consumer products and for the specific consumer product;
aggregating the estimated pmf values; and
using at least one estimated pmf value as an indicator of a consumer product defect and/or potential recall event.

16. The computer program product as set forth in claim 13, further comprising instructions for causing the one or more processors to perform an operation of modeling a number of consumer issues as a binomial distribution and conducting binomial tests in which low scores are indicative of a consumer product defect and/or potential recall event.

17. The computer program product as set forth in claim 13, wherein the set of heterogeneous data sources comprises at least two of forum data, information from content aggregation sites, online social media, and online complaint resources.

13. The computer program product as set forth in claim 13, further comprising instructions for causing the one or more processors to further perform an operation of identifying emergent events regarding vehicle defects and safety.

19. The system as set forth in claim 1, wherein the at least one indicator is declining engine efficiency of a vehicle.

20. The method as set forth in claim 7, wherein the at least one indicator is declining engine efficiency of a vehicle.
